(19) United States
(12) Patent Application Publication
(10) Pub. No.: US 2026/0116160 A1
(43) Pub. Date: Apr. 30, 2026

(54) Multipurpose Truck Bed Cover Device

(71) Applicant: Chris Stearns, Panama City, FL (US)

(72) Inventor: Chris Stearns, Panama City, FL (US)

(21) Appl. No.: 19/343,222

(22) Filed: Sep. 29, 2025

Related U.S. Application Data
(60) Provisional application No. 63/711,203, filed on Oct. 24, 2024.

(51) Int. Cl. B60J 7/06; B60J 7/04

(52) U.S. Cl. CPC B60J 7/068; B60J 7/042

(57) ABSTRACT

A multipurpose truck bed cover device is provided. The device is comprised of a truck bed cover designed to enhance the versatility of truck beds by offering three primary configurations: a bed cap mode for enclosed storage, a tonneau cover mode for low-profile coverage, and an open bed mode to restore the truck bed to its standard open layout. The device comprises a rectangular body with at least three side walls mounted on sliding tracks, a top wall that may fold, roll, or telescope, and locking mechanisms to secure configurations during operation. In motorized versions, electric motors powered by the truck's electrical system enable the raising and lowering of the body between modes as well as control of the top wall.

### CROSS-REFERENCE TO RELATED APPLICATION

The present application claims priority to, and the benefit of, U.S. Provisional Application No. 63/711,203, which was filed on Oct. 24, 2024, and is incorporated herein by reference in its entirety.

### FIELD OF THE INVENTION

The present invention relates generally to the field of truck bed covers. More specifically, the present invention relates to a multipurpose truck bed cover device that comprises a truck bed cover that can function as a bed cap and a tonneau cover. Accordingly, the present disclosure makes specific reference thereto. Nonetheless, it is to be appreciated that aspects of the present invention are also equally applicable to other like applications, devices, and methods of manufacture.

### BACKGROUND

Pickup trucks are frequently used for transporting various types of cargo, yet their open beds expose items to theft and environmental damage. While flat tonneau covers provide some level of protection, their rigid, flat construction restricts the types of cargo that can fit beneath them. In contrast, full truck bed cabs offer enhanced security and protection but are often cumbersome to install or remove, requiring specialized tools and significant effort. Additionally, such cabs can significantly obstruct the driver's rearward visibility, compromising safety. This lack of versatility in existing solutions creates challenges for users who need to balance accessibility, protection, and functionality. Truck owners often face the burden of swapping between different cover systems or dealing with the limitations of a single system. A more adaptable solution is needed to meet the diverse requirements of cargo transport while maintaining ease of use and operational safety.

Therefore, there exists a long-felt need in the art for a multipurpose truck bed cover device that allows convenient transitions between open bed, closed bed, and full cab configurations. There also exists a long-felt need in the art for a multipurpose truck bed cover device that provides comprehensive protection against theft and inclement weather while preserving driver visibility. Moreover, there exists a long-felt need in the art for a multipurpose truck bed cover device that simplifies operation through automated or manual mechanisms without requiring extensive effort or specialized tools.

The subject matter disclosed and claimed herein, in one embodiment thereof, comprises a multipurpose truck bed cover device. The device is comprised of a truck bed cover designed to enhance the versatility of truck beds by offering three primary configurations: a bed cap mode for enclosed storage, a tonneau cover mode for low-profile coverage, and an open bed mode to restore the truck bed to its standard open layout. The device comprises a rectangular body with at least three side walls mounted on sliding tracks, a top wall that may fold, roll, or telescope, and locking mechanisms to secure configurations during operation. In motorized versions, electric motors powered by the truck's electrical system enable the raising and lowering of the body between modes as well as control of the top wall.

In this manner, the multipurpose truck bed cover device of the present invention accomplishes all the forgoing objectives and provides a versatile truck bed cover solution that adapts to various user needs. More specifically, the device can transition between open bed, tonneau cover, and bed cap configurations, ensuring compatibility with a wide range of cargo types. The incorporation of automated controls, such as electric motors and user interfaces further enhances convenience and accessibility. By combining adaptability, protection, and ease of use, the multipurpose truck bed cover device provides a comprehensive solution to long-standing challenges in truck bed management.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose truck bed cover device designed to provide flexible truck bed storage and coverage options for truck owners. The device transitions between three primary modes: a raised bed cap for enclosed storage, a tonneau cover, and a fully retracted configuration to restore the truck bed to an open layout.

The device is comprised of a rectangular body with at least three side walls and a top wall forming an enclosure in bed cap mode. The side walls are mounted to sliding tracks attached to the truck bed's interior surface, allowing controlled vertical movement. The sliding tracks support manual or automated operation. Manual versions use low-friction or ball-bearing tracks with locking mechanisms for height adjustment. Automated versions incorporate electric motors powered by the truck's electrical system, controlled via dashboard switches, remotes, or mobile applications.

The top wall is available in folding, rolling, or telescoping configurations, with options for hard-top or soft-top construction. A locking member secures the top wall in open or closed positions, preventing unintended movement.

In bed cap mode, the side walls extend vertically, and the top wall spans the truck bed to create a secure, enclosed compartment for cargo protection. The viewing window provides visibility without opening the enclosure. In tonneau cover mode, the side walls retract to a flush position, and the top wall extends across the bed for low-profile coverage. The top wall can fully or partially cover the bed, with motorized or manual operation options. In open bed mode, the side walls fully retract, and the top wall is stored compactly, leaving the truck bed unobstructed. The locking member ensures secure storage during transit.

Accordingly, the multipurpose truck bed cover device of the present invention is particularly advantageous as it provides a versatile truck bed cover solution that adapts to various user needs. More specifically, the device can transition between open bed, tonneau cover, and bed cap configurations, ensuring compatibility with a wide range of cargo types. The incorporation of automated controls, such as electric motors and user interfaces further enhances convenience and accessibility. By combining adaptability, protection, and case of use, the multipurpose truck bed cover device overcomes the limitations of existing truck bed covers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multipurpose truck bed cover device of the present invention in a bed cap mode in accordance with the disclosed architecture;

FIG. 2 illustrates a perspective view of one potential embodiment of a multipurpose truck bed cover device of the present invention in a tonneau cover mode in accordance with the disclosed architecture;

FIG. 3 illustrates a perspective view of one potential embodiment of a multipurpose truck bed cover device of the present invention in a fully retracted mode in accordance with the disclosed architecture;

FIG. 4 illustrates a flowchart of a method of using one potential embodiment of a multipurpose truck bed cover device of the present invention in accordance with the disclosed architecture;

FIG. 5 illustrates a flowchart of a method of using one potential embodiment of a multipurpose truck bed cover device of the present invention in accordance with the disclosed architecture; and

FIG. 6 illustrates a flowchart of a method of using one potential embodiment of a multipurpose truck bed cover device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a multipurpose truck bed cover device that allows convenient transitions between open bed, closed bed, and full cab configurations. There also exists a long-felt need in the art for a multipurpose truck bed cover device that provides comprehensive protection against theft and inclement weather while preserving driver visibility. Moreover, there exists a long-felt need in the art for a multipurpose truck bed cover device that simplifies operation through automated or manual mechanisms without requiring extensive effort or specialized tools.

The present invention, in one exemplary embodiment, is comprised of a multipurpose truck bed cover device designed to offer adaptable storage and coverage solutions for truck owners. The device transitions between three primary configurations: a raised bed cap for enclosed storage, a tonneau cover, and a fully retracted position to restore the truck bed to an open state.

The device is comprised of a rectangular body with at least three side walls and a top wall forming an enclosure when in bed cap mode. The side walls are mounted on sliding tracks attached to the truck bed's interior surface, facilitating controlled vertical movement. The sliding tracks enable both manual and automated operation, with manual versions incorporating low-friction or ball-bearing mechanisms and locking systems for secure height adjustment. Automated configurations include electric motors powered by the truck's electrical system, operated through dashboard switches, remotes, or mobile applications.

The top wall is available in folding, rolling, or telescoping designs, with hard-top or soft-top construction options. A locking member ensures the top wall remains secure in both open and closed positions, preventing unintended movement during use or transit.

In bed cap mode, the side walls extend vertically, and the top wall spans the truck bed to create a secure, enclosed space for protecting cargo. A viewing window provides visibility without requiring the enclosure to be opened. In tonneau cover mode, the side walls retract to a flush position, and the top wall extends across the truck bed for low-profile coverage. The top wall can be adjusted to fully or partially cover the bed, with both manual and motorized operation options. In open bed mode, the side walls fully retract, and the top wall is compactly stored, leaving the truck bed unobstructed. The locking member secures the top wall in its stored position.

The multipurpose truck bed cover device is a highly versatile solution that adapts to various user needs, offering compatibility with different cargo types. The inclusion of automated controls, such as electric motors and user interfaces, enhances convenience and accessibility. By integrating adaptability, protection, and ease of use, the device addresses the limitations of conventional truck bed covers.

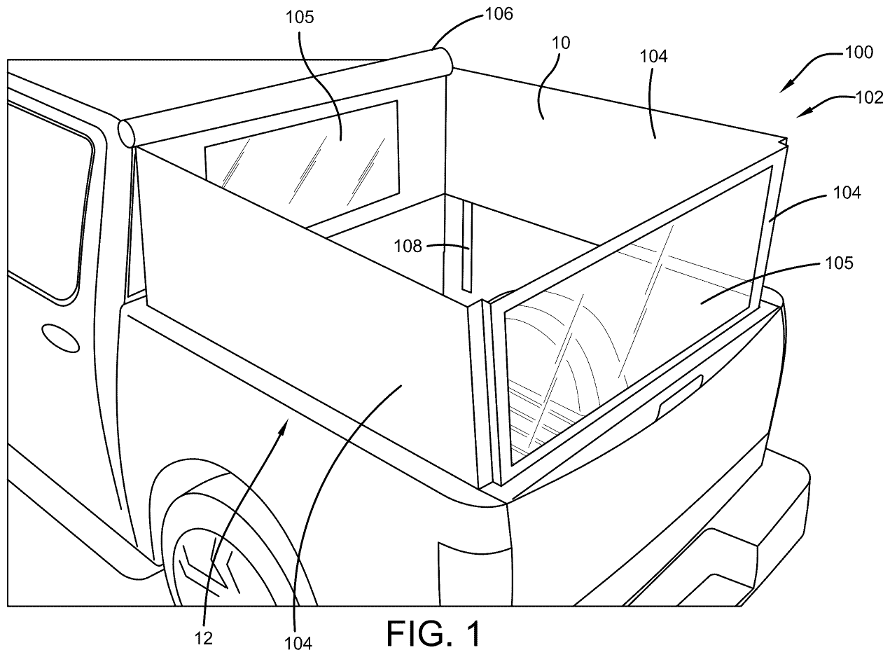

Referring initially to the drawings, FIG. 1 illustrates a perspective view of one potential embodiment of a multipurpose truck bed cover device 100 of the present invention in a bed cap mode in accordance with the disclosed architecture. The multipurpose truck bed cover device 100 is a versatile device designed to meet the diverse needs of truck owners. The device 100 is capable of transitioning between three primary configurations: a raised bed cap for enclosed storage, a tonneau cover, and a fully retracted configuration that restores the truck bed 12 to its standard open layout. This adaptability ensures that the device 100 can accommodate a wide range of cargo types, environments, and user preferences.

The device 100 is comprised of a generally rectangular body 102. The body 102 is preferably comprised of at least three side walls 104 and a top wall 106 that collectively form an enclosure when in bed cap mode. The side walls 104 are securely mounted to sliding tracks 108 that are fastened to the interior surface 10 of the truck bed 12, enabling controlled vertical movement for transitioning between the three use modes.

The side walls 104 may be constructed from lightweight rigid materials such as anodized aluminum or reinforced composite plastics. In a different embodiment, the side walls 104 are comprised of a non-rigid fabric material (e.g., a soft-top cover). At least one side wall 104 is comprised of a viewing window 105 (as seen in FIG. 1), which is made from transparent and impact-resistant materials, such as polycarbonate or tempered glass. The viewing window 105 allows visibility to the rear of the bed while the device 100 is in the bed cap mode, enhancing usability by enabling users to see cargo or other objects within the enclosed space.

The sliding tracks 108 enable vertical movement of the side walls 104 and may be configured for both manual and automated use. In manual configurations, the sliding tracks 108 incorporate ball-bearing tracks or low-friction tracks for vertical adjustment of the side walls 104. A locking mechanism 109, such as mechanical locks, spring-loaded pins, or cam-based systems, is integrated into the tracks 108 to securely hold the side walls 104 at a desired height during operation.

In automated embodiments, the sliding tracks 108 are equipped with high-torque electric motors 111 housed within the tracks 108 themselves. The motors 111 are powered by the truck's electrical system and are designed to provide sufficient power for raising and lowering the side walls 104 under various load conditions. Operation of the electric motors 111 is controlled through a user control interface 120, which may include but is not limited to dashboard-mounted switches, wireless remotes, or mobile applications. These controls provide users with flexible options for operating the device 100 conveniently and efficiently.

The top wall 106 of the device 100 is available in several configurations to meet the diverse requirements of truck owners. In one embodiment, the top wall 106 is comprised of a folding tonneau cover that stacks compactly near the cab when retracted, minimizing obstruction and maximizing bed accessibility. In another embodiment, the top wall 106 is comprised of a rolling cover made from durable and flexible materials that can roll into a cylindrical housing for compact storage. Yet another embodiment features a telescoping cover that slides out of the way of the truck bed 12. The top wall 106 may be constructed as a hard-top or as a soft-top.

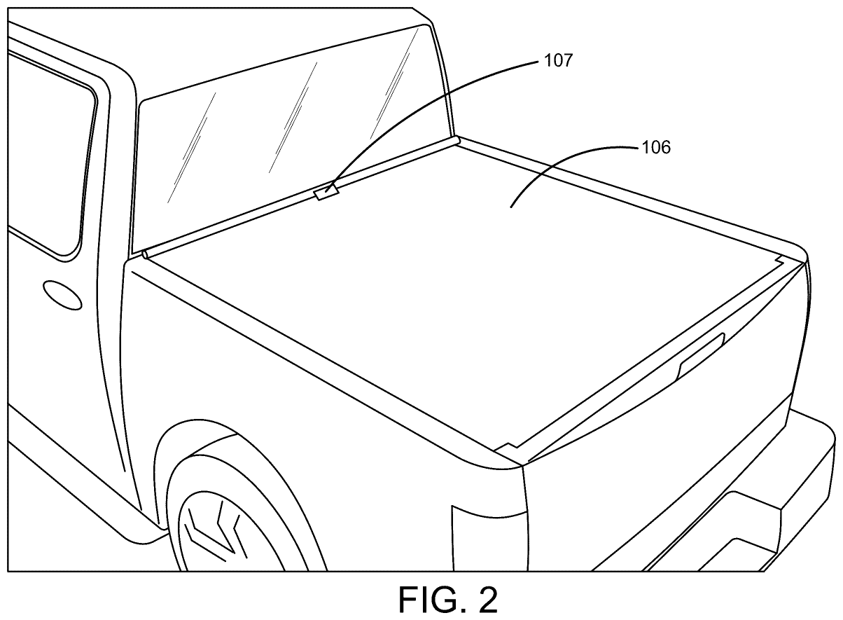

To ensure secure operation in any configuration, the device 100 is further equipped with a locking member 107, which is configured to secure the top wall 106 in both open and closed positions (as seen in FIG. 2). The locking member 107 may be mechanical such as but not limited to a latch, a clip, a pin, etc. The locking member 107 prevents unintended movement of the top wall 106 when opened or closed, ensuring that it remains stable while in use or during transit. This feature enhances the reliability and safety of the device 100 by preventing accidental deployment or retraction of the top wall 106, regardless of the specific embodiment or configuration used.

In bed cap mode, the side walls 104 extend vertically along the sliding tracks 108 to their maximum height, while the top wall 106 spans across the truck bed (shown in a retracted state in FIG. 1), forming a raised and enclosed storage compartment. This mode is particularly useful for protecting tools, equipment, or other valuable cargo from theft, weather, and debris. The inclusion of the viewing window 105 allows users to monitor the contents of the enclosed bed or view the rear surroundings without needing to open the enclosure. The locking member 107 secures the top wall 106 in the closed position during operation, ensuring that the enclosure remains intact and resistant to external forces such as wind or vibrations.

In tonneau cover mode as seen in FIG. 2, the side walls 104 slide downward into a flush position within the truck bed 12 via the tracks 108, aligning with the sides of the truck bed 12. In this use case, the top wall 106 extends across the truck bed to provide low-profile coverage of the bed 12. Depending on user needs, the top wall 106 can either completely cover the bed 12 for maximum protection or be adjusted to leave the bed partially exposed. The locking member 107 secures the top wall 106 in either the open or closed position as desired, maintaining stability during use. In one embodiment, the top wall 106 is a motorized wall that can be extended/retracted via the control interface 120.

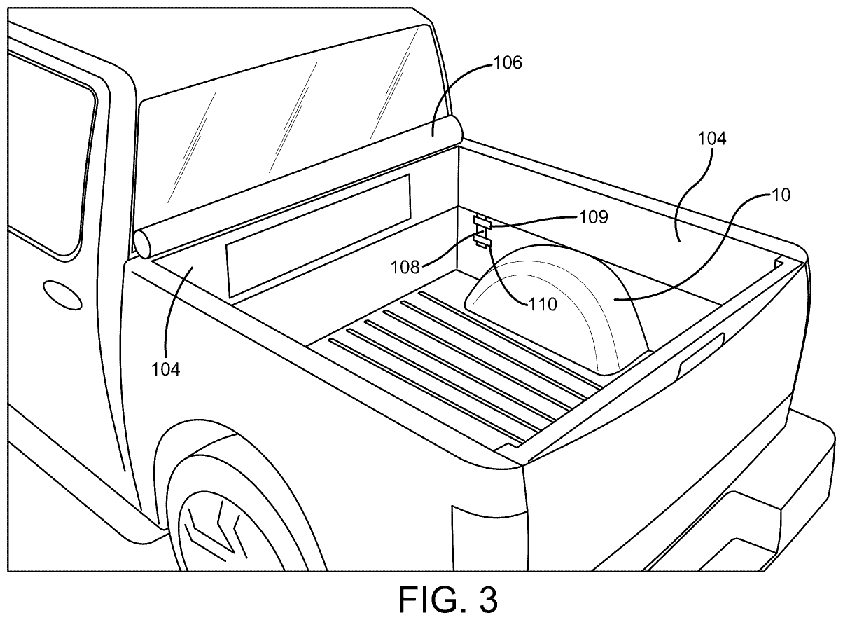

In open bed mode as seen in FIG. 3, the side walls 104 retract fully into the tracks 108, becoming flush with or hidden within the truck bed 12. Simultaneously, the top wall 106 can be folded, rolled, telescoped, or otherwise stored into its respective storage configuration, leaving the truck bed fully unobstructed. The locking member 107 ensures that the top wall 106 remains securely stored during transit or operation in open bed mode, preventing unintentional deployment.

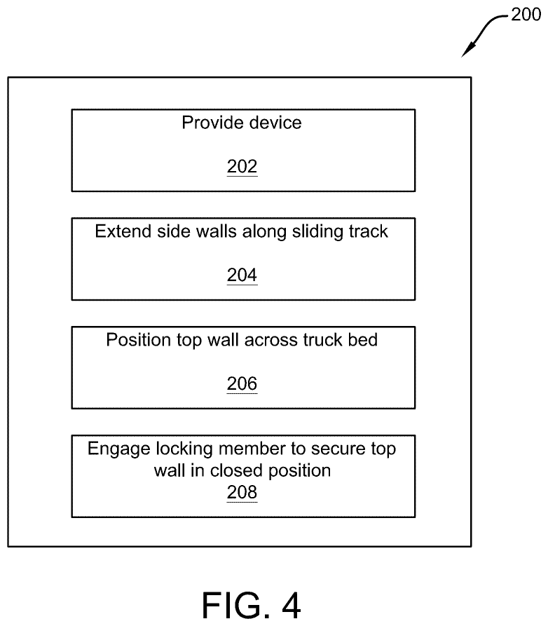

The present invention is also comprised of a method 200 of using the multipurpose truck bed cover device 100 in bed cap mode, as seen in FIG. 4. First, a device 100 is provided, comprised of a body 102 having at least three side walls 104, a top wall 106, and a locking member 107 [Step 202]. Then, the side walls 104 can be extended vertically along the sliding tracks 108 to their maximum height to create an enclosed structure [Step 204]. Next, the top wall 106 can be positioned to span across the truck bed 12, forming a secure enclosure [Step 206]. Finally, the locking member 107 can be engaged to secure the top wall 106 in the closed position to prevent movement during use or transit [Step 208].

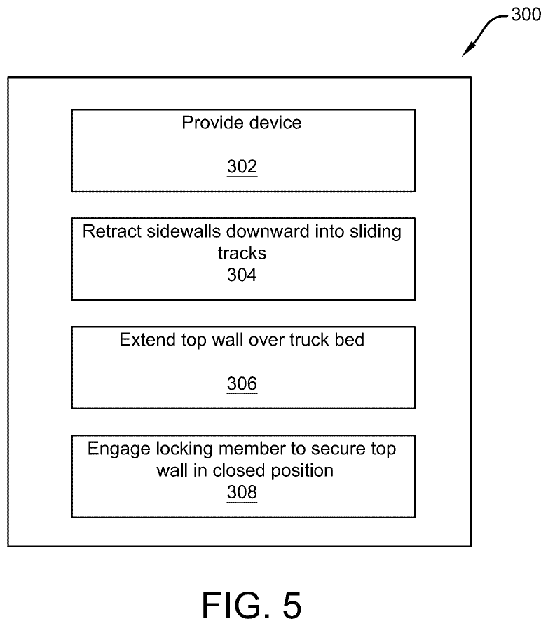

The present invention is also comprised of a method 300 of using the multipurpose truck bed cover device 100 in tonneau cover mode, as seen in FIG. 5. First, a device 100 is provided, comprised of a body 102 having at least three side walls 104, a top wall 106, and a locking member 107 [Step 302]. Then, the side walls 104 can be retracted downward into the sliding tracks 108 to a flush position within the truck bed 12 [Step 304]. Next, the top wall 106 can be extended over the truck bed 12, providing low-profile coverage [Step 306]. Finally, the locking member 107 can be engaged to secure the top wall 106 in the closed position to prevent unintentional movement during use [Step 308].

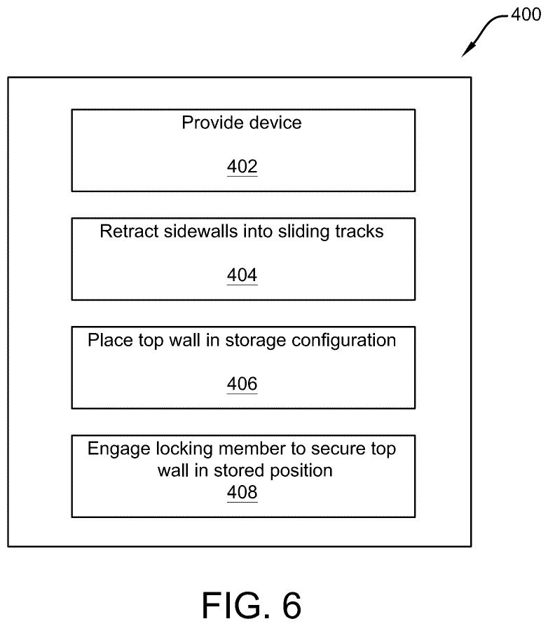

The present invention is also comprised of a method 400 of using the multipurpose truck bed cover device 100 in open bed mode, as seen in FIG. 6. First, a device 100 is provided, comprised of a body 102 having at least three side walls 104, a top wall 106, and a locking member 107 [Step 402]. Then, the side walls 104 can be retracted fully into the sliding tracks 108 so they are flush with or hidden within the truck bed 12 [Step 404]. Next, the top wall 106 can be folded, rolled, or telescoped into its storage configuration, leaving the truck bed unobstructed [Step 406]. Finally, the locking member 107 can be engaged to secure the top wall 106 in its stored position to prevent accidental deployment during transit or operation [Step 408].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multipurpose truck bed cover device” and “device” are interchangeable and refer to the multipurpose truck bed cover device 100 of the present invention.

Notwithstanding the forgoing, the multipurpose truck bed cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the multipurpose truck bed cover device 100 as shown in the FIGS. are for illustrative purposes only, and that many other sizes and shapes of the multipurpose truck bed cover device 100 are well within the scope of the present disclosure. Although the dimensions of the multipurpose truck bed cover device 100 are important design parameters for user convenience, the multipurpose truck bed cover device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multipurpose truck bed cover device comprising:
a body comprising a first side wall, a second side wall, a third side wall, and a top wall that form an enclosure;
a first sliding track comprised of a first locking mechanism and attached to the first side wall, and a second sliding track comprised of a second locking mechanism and attached to the second side wall; and
a locking mechanism integrated into the sliding tracks, the locking mechanism configured to secure the side walls at a desired vertical position during operation.

2. The multipurpose truck bed cover device of claim 1, wherein the top wall is comprised of a folding top wall.

3. The multipurpose truck bed cover device of claim 1, wherein the top wall is comprised of a rolling top wall.

4. The multipurpose truck bed cover device of claim 1, wherein the top wall is comprised of a telescopic top wall.

5. The multipurpose truck bed cover device of claim 1, wherein the top wall is comprised of a locking member.

6. The multipurpose truck bed cover device of claim 5, wherein the locking member is comprised of a clip, a latch, or a pin.

7. The multipurpose truck bed cover device of claim 1, wherein the first side wall, the second side wall, the third side wall, and the top wall are comprised of a rigid material.

8. The multipurpose truck bed cover device of claim 1, wherein the first sliding track and the second sliding track are comprised of a ball-bearing track.

9. A multipurpose truck bed cover device comprising:
a body comprising a first side wall, a second side wall, a third side wall, and a top wall that form an enclosure;
a first sliding track comprised of a first locking mechanism, a first electric motor, and attached to the first side wall, and a second sliding track comprised of a second locking mechanism, a second electric motor, and attached to the second side wall; and
a user control interface operatively connected to the first electric motor and the second electric motor.

10. The multipurpose truck bed cover device of claim 9, wherein the top wall is comprised of a folding top wall.

11. The multipurpose truck bed cover device of claim 9, wherein the top wall is comprised of a rolling top wall.

12. The multipurpose truck bed cover device of claim 9, wherein the top wall is comprised of a telescopic top wall.

13. The multipurpose truck bed cover device of claim 9, wherein the top wall is comprised of a motorized folding top wall, a motorized telescopic top wall, or a motorized rolling top wall.

14. The multipurpose truck bed cover device of claim 9, wherein the first side wall, the second side wall, the third side wall, and the top wall are comprised of a non-rigid material.

15. The multipurpose truck bed cover device of claim 9, wherein the user control interface is comprised of a remote.

16. The multipurpose truck bed cover device of claim 9, wherein the user control interface is comprised of a button.

17. The multipurpose truck bed cover device of claim 9, wherein the user control interface is comprised of a mobile application.

18. A multipurpose truck bed cover device comprising:
a body comprising a first side wall comprised of a viewing window, a second side wall, a third side wall, and a top wall that forms an enclosure;
a first sliding track comprised of a first locking mechanism, a first electric motor, and attached to the first side wall, and a second sliding track comprised of a second locking mechanism, a second electric motor, and attached to the second side wall; and
a user control interface operatively connected to the first electric motor and the second electric motor.

19. The multipurpose truck bed cover device of claim 18, wherein the top wall is comprised of a motorized folding top wall, a motorized telescopic top wall, or a motorized rolling top wall.

20. The multipurpose truck bed cover device of claim 18, wherein the user control interface is comprised of a remote, a button, or a mobile application.
